(19) United States
(12) Patent Application Publication
(10) Pub. No.: US 2013/0111902 A1
(43) Pub. Date: May 9, 2013

(54) Solar power system and method of operating a solar power system

(71) Applicants: Mansour Maleki-Ardebili, Erlangen (DE); Nishant Muley, Oviedo, FL (US); Thorsten Wolf, Orlando, FL (US)

(72) Inventors: Mansour Maleki-Ardebili, Erlangen (DE); Nishant Muley, Oviedo, FL (US); Thorsten Wolf, Orlando, FL (US)

(21) Appl. No.: 13/526,586

(22) Filed: Jun. 19, 2012

Related U.S. Application Data
(60) Provisional application No. 61/555,061, filed on Nov. 3, 2011.

(51) Int. Cl. F03G 6/06; F24J 2/30; F01K 9/02; F24J 2/04

(52) U.S. Cl. 60/641.11; 60/641.8; 126/640; 126/643; 60/692; 60/641.15

(57) ABSTRACT

A solar power system includes a steam turbine with a plurality of pressure stages, a first solar field for heating water or water steam, and a first heat exchanger. The first heat exchanger is operated with molten salt liquids. Further, with a method of operating such a solar power system, water steam from the first solar field is transferred to the first heat exchanger, where the water steam is heated by the first heat exchanger and routed to a high pressure stage of the steam turbine.

### CROSS REFERENCE TO RELATED APPLICATIONS

The application claims the benefit of U.S. provisional application No. 61/555,061 filed Nov. 03, 2011, which is incorporated by reference herein in its entirety.

### FIELD OF INVENTION

A solar power system and a method for operating such a solar power system are provided.

### BACKGROUND OF INVENTION

Concentrated solar power (CSP) systems use mirrors or lenses to concentrate a large area of sunlight, or solar thermal energy, onto a small area. Electrical power is produced when the concentrated light is converted to heat, which drives a heat engine, for example a steam turbine, connected to an electrical power generator.

The incident solar radiation is concentrated and stored in a system which includes for example thermal fluid like oil, salt, air, or other media. The fluid is then used directly or indirectly for thermal expansion in a steam turbine. There are four CSP-technologies developed during the last years: Direct Steam (Linear Fresnel or Power Tower), Heat Transfer Fluid-HTF-oil (Trough), Molten Salt (Trough or Power Tower) and Parabolic Dish Engine (Stirling).

Linear Fresnel (direct steam) technology means that sun radiation is focused in an array of long, flat or slightly curved tracking mirrors on a linear receiver pipe positioned above the array. Flat mirrors are much easier to produce and cost remarkably lower than the Trough technology with higher curved mirrors. Instabilities appear with a phase change which leads to non-homogeneous temperature distributions that generate thermal stress. The Linear Fresnel technology is still at a first development level compared to other CSP technologies.

Direct Steam production can also be achieved with Power Tower technologies. Advantages of the Power Tower technology are higher life steam temperatures and a reheat possibility. Disadvantages of the Power Tower Direct Steam technology are higher investment costs compared to Linear Fresnel. Direct Steam is much more sensitive to clouds and environmental impacts. These could lead to a much faster temperature fluctuations of the Linear Fresnel Technology.

### SUMMARY OF INVENTION

An improved solar power system, in particular a combined direct steam/molten salt solar power system, is provided. Further, a method of operating the improved direct steam solar power system is provided.

Direct Steam (Linear Fresnel & Power Tower) and Molten Salt (Trough & Power Tower) are two different technologies already used for CSP power plants. The major advantage of the direct steam Linear Fresnel (LF) compared to other technologies is lower investment costs. Linear Fresnel is currently the only solar CSP-technology which achieves the investment level of conventional fossil fired power plants. The actual kilowatt (kW)-costs of a plant with Linear Fresnel technology amounts to 2000 Euros. The costs of electricity are estimated to about 15 Cents (Euro) per kilowatt hour (kWh).

Disadvantages of Linear Fresnel are the lack of the capability of heat storage and the sensitivity to the dynamic of the solar field which is highly dependent from the environmental atmospheric fluctuations and leads to very high temperature gradients (nearly 50K/min for several minutes). Steam storage in systems using Direct Steam is difficult and not effective compared to Molten Salt or HTF-oil technologies. A reheat system is not very efficient for the LF-technology since reheat steam is split from the main steam mass flow. Molten Salt plants have, according to the dynamic of the cycle, a much better behavior and the storage capability for compensating time periods with low/no Direct Normal Irradiance (DNI).

The improved solar power system combines Direct Steam and Molten Salt technologies. In an embodiment, the solar power system comprises a Linear Fresnel (LF)-cycle, which is a Direct Steam technology, and a Molten Salt (MS)-cycle.

The solar power system combining both technologies Direct Steam and Molten Salt reduces costs comparing to a pure Molten Salt solar system. Further, the Direct Steam plant technology is improved regarding cycle efficiency, possibility of thermal storage and dynamics, wherein high temperature gradients are avoided.

The molten salt heat exchanger unit is part of the MS-cycle and comprises two components: a first molten salt heat exchanger, which is connected with an upstream LF-field in order to increase the steam temperature of the LF-cycle. The second component of the molten salt heat exchanger unit is a second molten salt heat exchanger which may substitute the LF-field in case of low DNI, for example at night. Further molten salt heat exchangers for a reheat or a double reheat concept may be provided.

In front of the heat exchangers, two molten salt tanks including molten salt liquids with high and low temperatures (also called hot tank and cold tank) are installed. Evaporation and superheating takes place by extracting molten salt from the hot tank, transferring heat to the first molten salt heat exchanger (superheater and reheater) to the LF-cycle (water/steam-cycle) and transferring the cooled molten salt fluid to the cold tank.

For time periods with high DNI (daytime), steam is produced with the LF-field of the LF-cycle and super heated with the first molten salt heat exchanger. For low/no DNI (nighttime), the LF-field may be switched off and all molten salt heat exchangers are in operation.

In an embodiment, Direct Steam (DS) technology is the leading component in the combined solar power system and a startup of a DS-cycle is undertaken by the LF-cycle. After reaching a minimum steam quality, the second cycle, MS-cycle, is set into operation.

Steam from the Linear Fresnel-cycle may also be used to warm up the molten salt at a boiler inlet. Thus, a minimum final feed water temperature (FFWT) is not a restriction anymore for Molten Salt plants.

The combination of the Direct Steam technology with a secondary solar solution, which is the Molten Salt technology, provides a system which
is a more efficient reheat solution compared to the reheat or non-reheat Linear Fresnel solution,
increases live steam and reheat steam temperatures reached by the Linear Fresnel technology in order to increase cycle efficiency,
stores heat to supplement low sun radiation (the design of the storage system depends on the maximum operation hours with storage), and
solves problems with a high temperature gradient because of sudden shortfalls of the sun radiation caused by clouds or other environmental impacts.

Further, the Molten Salt technology provides heat storage and a high salt temperature, depending on the salt combination, wherein the salt temperature may be for example 600° C. compared to 380° C. of HTF thermal oil.

### BRIEF DESCRIPTION OF THE DRAWINGS

FIG. 1 shows a combined solar power system in an embodiment for normal operation.

FIG. 2 shows a combined solar power system in the embodiment of FIG. 1 for storage operation.

FIG. 3 shows a heat balance diagram (HBD) for combined solar power system.

### DETAILED DESCRIPTION OF INVENTION

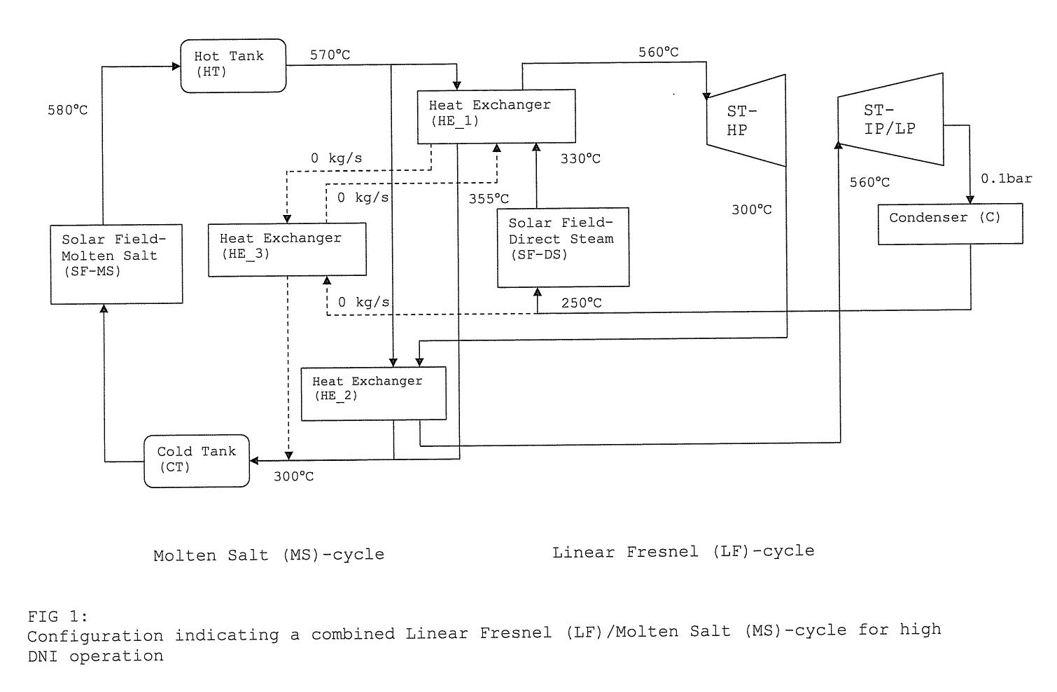

FIG. 1 shows a combined solar power system in an embodiment for normal operation, comprising a Direct Steam-Linear Fresnel-cycle and a Molten Salt-cycle.

The Linear Fresnel-cycle (LF) comprises a steam turbine (ST) with a high pressure section (HP) and an intermediate/low pressure section (IP/LP), a condenser (C) and a solar field (SF-DS) for heating water or water steam. The solar field (SF-DS) may be a Linear Fresnel-field with in an array of long, flat or slightly curved tracking mirrors on a linear receiver pipe with water as the heat transferring medium positioned above the array.

Alternatively, the solar field (SF-DS) may be a solar power tower/central receiver with a circular array of flat heliostats (sun tracking mirrors) concentrating sunlight on to a central receiver at the top of a tower. Water, the heat transfer medium, in the receiver absorbs the thermal energy and transfers it into a steam cycle to generate heated steam for the steam turbine.

The solar field (SF-DS) heats water or water steam to saturated or superheated temperatures.

The molten salt-cycle (MS) comprises a first heat exchanger (HE1), a second heat exchanger (HE2) and a third heat exchanger (HE3). All heat exchangers (HE1-HE3) are operated with molten salt liquids. Heat exchangers HE1 and HE2 produce superheated live and reheat steam. Heat exchanger HE3 substitutes the Linear Fresnel solar field during low DNI.

The first heat exchanger (HE1) receives water steam from the solar field (SF-DS) of the LF-cycle, having a temperature of about 300-330° C., super heats the water steam to 560-600° C., and feeds the heated water steam to the high pressure stage (HP) of the steam turbine (ST).

The second heat exchanger (HE2) receives expanded water steam leaving the high pressure steam turbine (HP), having a temperature of about 300-330° C., heats the water steam to a specified reheat temperature, and feeds the superheated steam to the intermediate/low pressure part of the steam turbine (IP/LP).

All pressure stages of the steam turbine (ST), i.e. the high pressure stage (HP) and the intermediate/low pressure stage (IP/LP), are operated with hot steam having a temperature of 560-600° C. The steam turbine (ST) may have a plurality of stages which are more stages than shown in the embodiment according to FIG. 1.

The third heat exchanger (HE3) is used for heat storage during daytime, i.e. heat which is not used during daytime operation is stored in the molten salt hot tank (HT). The stored heat may then be used at night instead of the solar field (SF-DS), since there is no solar power available at night or during overcast weather conditions (low/no DNI). The third heat exchanger (HE3) substitutes the solar field (SF-DS) of the LF-cycle (LF) at times with low or no DNI, for example at night. For example, the solar field (SF-DS) may be switched off when the sun radiation (DNI) falls below a predetermined threshold.

Instead, the third heat exchanger (HE3) will be operated as steam generation device for heating the water steam to saturated or superheated conditions. The third heat exchanger is also operated with molten salt liquids.

The MS-cycle (MS) further comprises a solar field for heating the molten salt (SF-MS) which may be a solar power tower/central receiver or parabolic trough technology. Parabolic system use mirrors to focus sunlight onto an absorber tube (receiver) placed in the trough's focal line. The troughs are designed to track the sun along one axis. The receivers contain a heat transfer fluid, for example molten salt, which is heated by the focused sunlight.

A hot tank (HT) and a cold tank (CT) with molten salt liquids are connected to the molten salt solar field (SF-MS). The heat exchangers (HE1, HE2 and HE3) are connected to the hot tank (HT) and the cold tank (CT).

The LF-water/steam-cycle (LF) operates as follows: The solar field (SF-DS) heats water and generates saturated or superheated steam from feed water temperatures below 300° C. The saturated or superheated steam runs through the first heat exchanger (HE1) of the molten salt cycle (MS), wherein the steam temperature is increased to 560-600° C. The steam with 560-600° C. is routed to the high pressure section (HP) of the steam turbine (ST). After the steam has been expanded in the high pressure turbine (HP), the steam has a lower temperature than the live steam temperature and is heated by the second molten salt heat exchanger (HE2) to 560-600° C. again. Following, the steam with 560-600° C. is supplied to the intermediate/low pressure stages (IP/LP) of the steam turbine (ST) expanding the steam and routing the expanded steam to the condenser (C).

The condenser (C) condenses the steam to a temperature below 300° C. and the condensed steam is then again routed to the solar field (SF-DS), where the LF-cycle starts again. As long as there is enough DNI, i.e. sun radiation, available, the LF-water/steam-cycle (LF) operates as described.

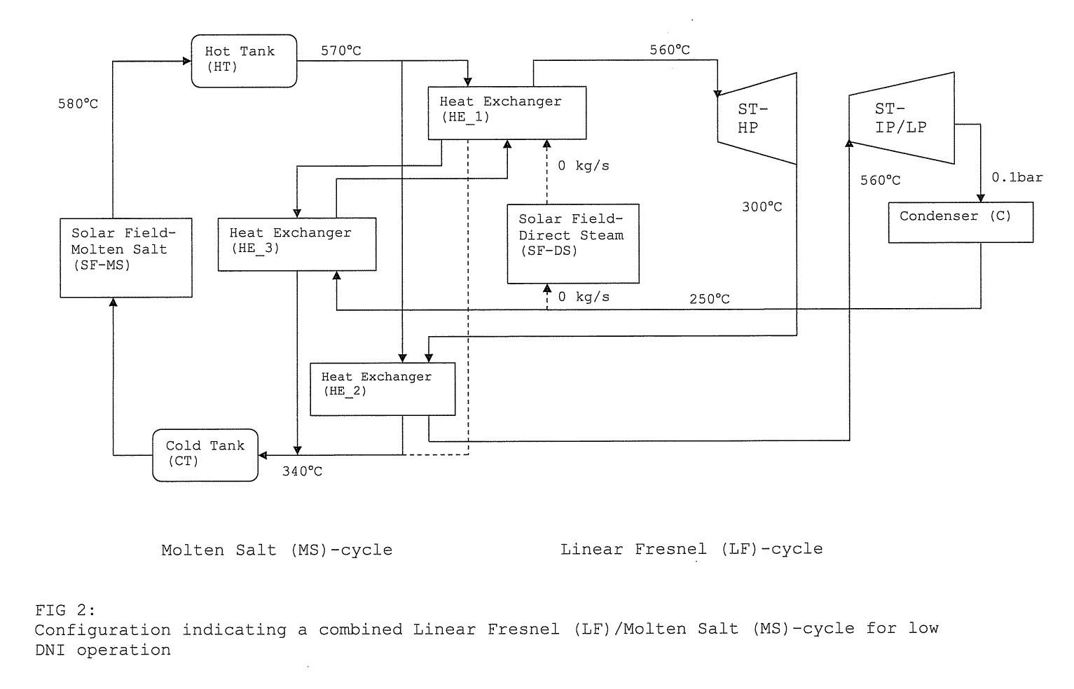

A different cycle will be described in FIG. 2 when there is not enough DNI (measure for sun radiation) available, for example during nighttime or during overcast weather conditions. According to the dotted lines from the condenser (C) to the third heat exchanger (HE3) and then to the first heat exchanger (HE1) of FIG. 1, the third heat exchanger (HE3) is only operating as storage unit during normal operation of the solar power system.

The molten salt-cycle (MS) operates as follows: The cold tank (CT) comprises cool molten salt liquids with a temperature of 300-350° C. These cold molten salt liquids are heated via the molten salt solar field (SF-MS) to a temperature of 560-580° C. The heated molten salt liquids are transferred to the hot tank (HT).

The hot molten salt liquids are used to operate all the heat exchangers (HE1, HE2 and HE3). Primarily, the first heat exchanger (HE1), and the second heat exchanger (HE2) are operated with the molten salt solar field (SF-MS).

Heat, which is not used in the first heat exchanger (HE1) for heating the steam of the LF-cycle (LF) to 560-600° C., is transferred to the cold tank (CT).

After the molten salt exits the first and second heat exchangers (HE1 and HE2), now with a lower temperate of 340-355° C., the cooled molten salt is transferred back to the cold tank (CT), where the cycle starts again.

The temperatures shown in FIG. 1 are only examples according to one embodiment and may vary within certain temperature ranges, for example within +/−10%.

FIG. 2 shows a combined solar power system in the embodiment of FIG. 1 for storage operation. The solar power system of FIG. 2 comprises the same components as the solar power system of FIG. 1.

As shown in FIG. 1, for time periods with high DNI, which is mainly during daytime, steam is produced with the solar field (SF-DS) of the LF-cycle and super heated with the first molten salt heat exchanger (HE1).

For low/no DNI, for example at night or during overcast weather conditions, the solar field (SF-DS) of the LF cycle (LF) may be switched off, i.e. not operating, and all heat exchangers (HE1, HE2 and HE3) are in operation. The dotted lines to, away from and around SF-DS means that the solar field of the LF-cycle (SF-DS) is not in operation.

Instead of heating the steam with the solar field (SF-DS) of the LF-cycle (LF), the steam is now heated with the third heat exchanger (HE3) functioning as heating unit from 300-330° C. to 560-600° C.

The first and second heat exchangers (HE1 and HE2) are also operating since the MS-cycle (MS) is able to store heat in the molten salt liquids.

With the combined solar power system, increasing live steam and reheat temperatures of 560-600° C./560-600° C. are provided. For all the pressure stages of the steam turbine (ST), high pressure (HP) and intermediate/low pressure (IP/LP), temperatures of 560-600° C., respectively, are provided.

The solar power system may be operated day and night, since stored heat in the third heat exchanger (HE3) may be used to heat the steam at night or during times of low/no DNI, for example sudden clouding, while the solar field (SF-DS) of the LF-cycle (LF) is operated during the day for heating the steam.

High temperature gradients, caused by sudden clouding or other environmental causes, are avoided which may lead to an increased turbine trip by using a constant minimum molten salt operation.

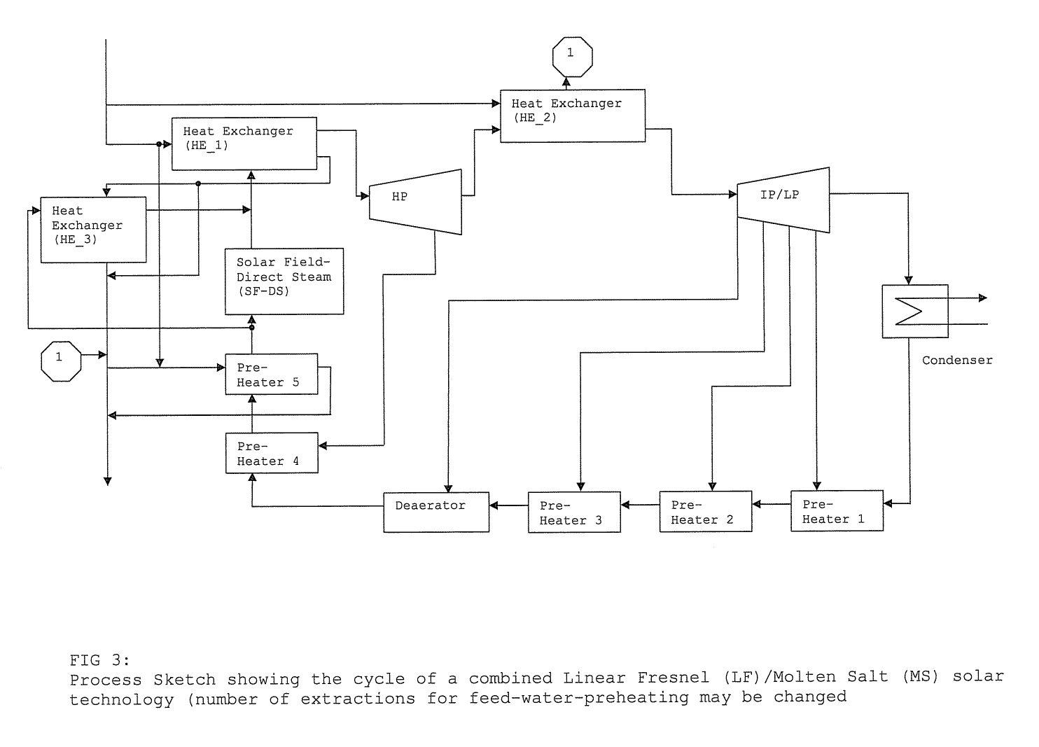

FIG. 3 shows a process sketch for a combined solar power system. The sketch includes the following features of the combined solar power system with a direct steam-cycle and molten salt-cycle: increasing the life steam temperature to 560° C., additional reheat with 560° C., molten salt heat exchanger (evaporator) parallel to the direct steam (Linear Fresnel) field for low/no sun radiation (DNI) and for avoiding high temperature gradients, and pre-heating of the feed water by substituting a pre-heater of an original direct steam-LF-cycle by a molten salt heat exchanger.

A process sketch for an estimated cycle improvement takes into account all the measures for the cycle improvement of the direct steam. Two measures, namely increasing the life steam temperature and inserting reheat aggregate (by molten salt heat exchanger) are taken into account for the linear Fresnel technology. Other measures could be applied for all other direct steam procedures like the Power Tower Technology. These are as mentioned before: additional permanent minimum molten salt operation to avoid large temperature gradients of direct steam, substituting a pre-heater of the LF-cycle by one or more molten salt heat exchangers. The storage possibility during periods of time with low/no sun radiation is not taken into account in the heat balance diagram. The expected cycle improvement by using higher life steam and reheat temperatures is 5-6% compared to a pure non-reheat Linear Fresnel cycle.

Further cycle improvements may also take a double reheat concept into account: In addition to the first reheater (HE2), a further reheater provides cycle improvement. The concept of double reheat is already known in the power plant industry. This option requires some modifications of the water-steam cycle and the steam turbine.

The investment costs for the proposed combined solar power system may be estimated from the following simple considerations:

Conservative values mentioned in different articles and analyses for a 50 MW plant are: investment costs of LF-cycle=2200 Euro/KW (power block & solar field), and investment costs of MS-cycle=4000 Euro/KW (power block & solar field).

A heat ratio between the LF-cycle and the MS-cycle is approximately: Heat (MS)/Heat (LF)=0.4. Taking into account the ratio of 0.4 for investment costs of a combined solar power plant, the investment costs of such a combined solar power plant (LF/MS) may results to: 2200 Euro/KW*0.6+4000 Euro/KW*0.4≈2900 Euro/KW. This consideration does not take the improvement plant efficiency from the combined technologies into account Improved plant efficiency results are smaller solar fields and remarkable cost savings.

While specific embodiments have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

1. Solar power system, comprising:
a steam turbine with a plurality of pressure stages,
a first solar field for generating steam, and
a first heat exchanger, wherein the first heat exchanger is operated with molten salt liquids.

2. The solar power system as claimed in claim 1, wherein the first heat exchanger heats water steam to a higher temperature before the steam is routed to a high pressure stage of the steam turbine.

3. The solar power system as claimed in claim 1, further comprising:
a second solar field for heating molten salt liquids, and
a cold tank and a hot tank for storage operation,
wherein the cold tank and the hot tank each comprise molten salt liquids and are each connected to the second molten salt solar field,
wherein the molten salt liquids of the cold tank have a lower temperature than the molten salt liquids of the hot tank,
wherein the cold tank transfers molten salt liquids to the second solar field, and
wherein the second solar field heats the molten salt liquids and transfers the molten salt liquids to the hot tank.

4. The solar power system as claimed in claim 3, wherein the molten salt liquids of the hot tank are supplied to the first heat exchanger.

5. The solar power system as claimed in claim 1, further comprising:
a second heat exchanger operated with molten salt liquids, wherein the second heat exchanger heats water steam to a higher temperature before the water steam is routed to an intermediate and/or low pressure stage of the steam turbine.

6. The solar power system as claimed in claim 5, wherein the solar power system comprises an additional heat exchanger operated with molten salt liquids for a double reheat of the water steam before the water steam is routed to a pressure stage of the team turbine.

7. The solar power system as claimed in claim 1, further comprising:
a third heat exchanger operated with molten salt liquids, wherein the third heat exchanger is operated as steam generator.

8. The solar power system as claimed in claim 7, wherein the first solar field is switched off when the third heat exchanger is operated as steam generator.

9. The solar power system as claimed in claim 5, further comprising:
a condenser for condensing water steam, wherein the condenser is connected downstream of the intermediate and/or low pressure stage of the steam turbine and condenses the water steam after exiting the intermediate and/or low pressure stage of the steam turbine, and wherein the condensed water steam is transferred to the first solar field or for low DNI to the third heat exchanger.

10. The solar power system as claimed in claim 7, wherein condensed water steam is generated in the third heat exchanger, when sun radiation (DNI) is below a predetermined threshold and/or within a predetermined time frame.

11. The solar power system as claimed in claim 1, wherein the first solar field for heating water or steam comprises a Linear Fresnel(LF)-field with a plurality of long, flat or slightly curved, tracking mirrors on a linear receiver pipe positioned above the array.

12. The solar power system as claimed in claim 1, wherein the solar field for heating water or steam comprises a solar power tower and a central receiver with a circular array of sun tracking mirrors concentrating sunlight on to a central receiver at the top of a tower.

13. Method of operating a solar power system, comprising:
providing
a steam turbine with a plurality of pressure stages,
a first solar field for generating steam, and
a first heat exchanger,
operating the first heat exchanger with molten salt liquids,
transferring water steam from the first solar field to the first heat exchanger,
heating the water steam by the first heat exchanger, and
routing the water steam to a high pressure stage of the steam turbine.

14. The method as claimed in claim 13,
providing a second heat exchanger operated with molten salt liquids,
heating expanded water steam after leaving the high pressure stage of the steam turbine by the second heat exchanger, and
routing the heated water steam to an intermediate/low pressure stage of the steam turbine.

15. The method as claimed in claim 14, wherein the first heat exchanger and the second heat exchanger each heat water steam to a higher temperature before the water steam is routed to a pressure stage of the steam turbine.

16. The method as claimed in claim 13, further comprising:
providing a third heat exchanger operated with molten salt liquids, wherein the third heat exchanger is operated as steam generator.

17. The method as claimed in claim 16, further comprising:
switching off the first solar field, and
generating steam by the third heat exchanger, operated as steam generator, instead of the first solar field.

18. The method as claimed in claim 17, wherein the first solar field is switched off and the third heat exchanger is operated as the steam generator
when sun radiation (DNI) is below a predetermined threshold and/or
within a predetermined time frame.

19. The method as claimed in claim 13, further comprising:
connecting each heat exchanger to a cold tank with the molten salt liquids and a hot tank with the molten salt liquids, wherein the molten salt liquids in the cold tank comprise a lower temperature than the molten salt liquids in the hot tank, and wherein the first and second heat exchangers are charged with molten salt liquids from the hot tank.

20. The method as claimed in claim 19, wherein the molten salt liquids, which are reverted to the cold tank, are reheated by a second solar field connected to the cold tank.
